(19) United States
(12) Patent Application Publication
(10) Pub. No.: US 2019/0193726 A1
(43) Pub. Date: Jun. 27, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Makoto Ishikawa, Wako-shi (JP); Hiroshi Miura, Wako-shi (JP); Masamitsu Tsuchiya, Wako-shi (JP); Koji Kawabe, Wako-shi (JP)

(21) Appl. No.: 16/218,513

(22) Filed: Dec. 13, 2018

(30) Foreign Application Priority Data
Dec. 27, 2017 (JP) 2017-250996

(51) Int. Cl. B60W 30/09; B60W 30/095; B60W 30/18

(52) U.S. Cl. CPC B60W 30/09; B60W 30/0956; B60W 2550/308; B60W 2550/306; B60W 30/18163

(57) ABSTRACT

A vehicle control device according to an embodiment includes a recognition unit that recognizes moving bodies present near a subject vehicle, a deriving unit that derives an index value indicating that a following vehicle present behind the subject vehicle in a subject lane among the moving bodies recognized by the recognition unit approaches the subject vehicle, and a driving control unit that performs predetermined control in a case that the index value derived by the deriving unit is smaller than a threshold value in a case that the subject vehicle changes a route to another lane.

### CROSS-REFERENCE TO RELATED APPLICATION

Priority is claimed on Japanese Patent Application No. 2017-250996, filed Dec. 27, 2017, the content of which is incorporated herein by reference.

### BACKGROUND OF THE INVENTION

### Field of the Invention

The present invention relates to a vehicle control device, a vehicle control method, and a storage medium.

### Description of Related Art

In recent years, a technology for supporting driving of a driver has been developed. For example, a technology for performing inter-vehicle communication between a public vehicle such as a bus or a taxi and a nearby vehicle traveling near the public vehicle, transmitting travel information of the public vehicle to the nearby vehicle, and supporting driving of the nearby vehicle is known (for example, Japanese Patent No. 5994526).

### SUMMARY OF THE INVENTION

However, execution of driving support such as contact avoidance for a following vehicle that does not perform inter-vehicle communication is not considered in the related art.

An aspect of the present invention has been made in consideration of such circumstances, and an object of the present invention is to provide a vehicle control device, a vehicle control method, and a storage medium capable of executing more appropriate contact avoidance control for a following vehicle.

A vehicle control device, a vehicle control method, and a storage medium according to the present invention adopt the following configurations.

(1) A vehicle control device according to an aspect of the present invention is a vehicle control device including: a recognition unit that recognizes moving bodies present near a subject vehicle; a deriving unit that derives an index value indicating that a following vehicle present behind the subject vehicle in a subject lane among the moving bodies recognized by the recognition unit approaches the subject vehicle; and a driving control unit that performs predetermined control in a case that the index value derived by the deriving unit is smaller than a threshold value in a case that the subject vehicle changes a route to another lane.

(2) In the aspect (1), the vehicle control device further includes an outside notification unit that performs a predetermined notification to surroundings of the subject vehicle, wherein the driving control unit performs a notification using the outside notification unit in a case that the index value derived by the deriving unit is smaller than a threshold value in a case in which the subject vehicle changes a route to another lane.

(3) In the above aspect (1), the deriving unit derives a headway time obtained by dividing a relative distance between the subject vehicle and the following vehicle by a speed of the following vehicle, as the index value.

(4) In the above aspect (1), the driving control unit performs the predetermined control in a case that it is predicted that the moving body recognized by the recognition unit will interfere with the subject vehicle in a case that the subject vehicle turns right or turns left to change the route.

(5) A vehicle control method according to an aspect of the present invention is a vehicle control method including recognizing, by a recognition unit, moving bodies present near a subject vehicle; deriving, by a deriving unit, an index value indicating that a following vehicle present behind the subject vehicle in a subject lane among the moving bodies recognized by the recognition unit approaches the subject vehicle; and performing, by a driving control unit, predetermined control in a case that the index value derived by the deriving unit is smaller than a threshold value in a case that the subject vehicle changes a route to another lane.

(6) A storage medium according to an aspect of the present invention is a computer-readable non-transitory storage medium storing a program, the program causing a computer to: recognize moving bodies present near a subject vehicle; derive an index value indicating that a following vehicle present behind the subject vehicle in a subject lane among the recognized moving bodies approaches the subject vehicle; and perform predetermined control in a case that the derived index value is smaller than a threshold value in a case that the subject vehicle changes a route to another lane.

According to the above aspects (1) to (6), it is possible to execute more appropriate contact avoidance control for a following vehicle.

### BRIEF DESCRIPTION OF THE DRAWINGS

FIG. 1 is a configuration diagram of a vehicle system using a vehicle control device according to an embodiment.

FIG. 2 is a functional configuration diagram of a first control unit and a second control unit.

FIG. 3 is a diagram illustrating a state in which a target trajectory is generated on the basis of a recommended lane.

FIG. 4 is a diagram illustrating an example of a process of an index value deriving unit.

FIG. 5 is a diagram illustrating an example of a process of a contact avoidance control unit.

FIG. 6 is a diagram illustrating an example of first contact avoidance control.

FIG. 7 is a diagram illustrating an example of second contact avoidance control.

FIG. 8 is a flowchart illustrating an example of a process that is executed by an automated driving control device according to the embodiment.

FIG. 9 is a diagram illustrating an example of a hardware configuration of the automated driving control device according to the embodiment.

### DESCRIPTION OF EMBODIMENTS

Hereinafter, embodiments of a vehicle control device, a vehicle control method, and a storage medium according to the present invention will be described with reference to the drawings. In the following description, an automated driving vehicle will be used for description. Automated driving is control of one or both of steering and acceleration/deceleration of a vehicle to cause the vehicle to travel regardless of an operation of an occupant. Manual driving of the automated driving vehicle may be performed by an occupant. Further, a case in which left-hand driving is applied will be described below, but the right and the left may be reversed in a case that right-hand driving is applied.

[Overall Configuration]

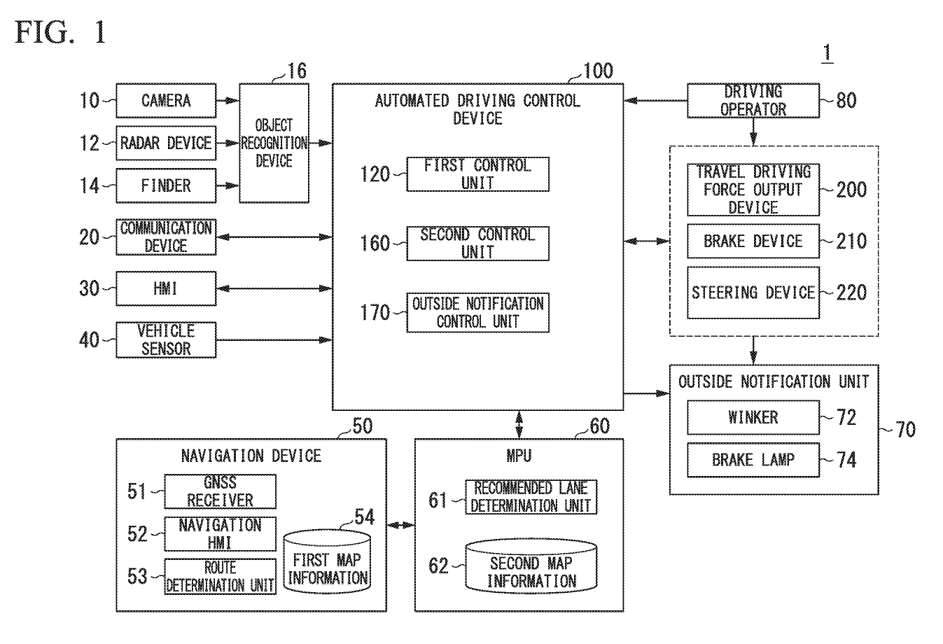

FIG. 1 is a configuration diagram of a vehicle system 1 using a vehicle control device according to an embodiment. A vehicle on which the vehicle system 1 is mounted is, for example, a vehicle such as a two-wheeled vehicle, a three-wheeled vehicle, or a four-wheeled vehicle. A driving source thereof is an internal combustion engine such as a diesel engine or a gasoline engine, an electric motor, or a combination thereof. When the electric motor is included, the electric motor operates using power generated by a power generator connected to the internal combustion engine, or discharge power of a secondary battery or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, an outside notification unit 70, a driving operator 80, an automated driving control device (an example of a vehicle control device) 100, a travel driving force output device 200, a brake device 210, and a steering device 220. These units or devices are connected to each other by a multiplex communication line such as a controller area network (CAN) communication line, a serial communication line, or a wireless communication network. The configuration illustrated in FIG. 1 is merely an example, and a part of the configuration may be omitted or another configuration may be added.

The camera 10 is, for example, a digital camera using a solid-state imaging device such as a charge coupled device (CCD) or a complementary metal oxide semiconductor (CMOS). One or a plurality of cameras 10 are attached to any places of the vehicle (hereinafter referred to as a subject vehicle M) on which the vehicle system 1 is mounted. In the case of imaging the front, the camera 10 is attached to an upper portion of a front windshield, a rear surface of a rearview mirror, or the like. The camera 10, for example, periodically repeatedly images the periphery of the subject vehicle M. The camera 10 may be a stereo camera.

The radar device 12 radiates radio waves such as millimeter waves to the surroundings of the subject vehicle M and detects radio waves (reflected waves) reflected by an object to detect at least a position (distance and orientation) of the object. One or a plurality of radar devices 12 are attached to any places on the subject vehicle M. The radar device 12 may detect a position and a speed of the object using a frequency modulated continuous wave (FM-CW) scheme.

The finder 14 is a light detection and ranging (LIDAR). The finder 14 radiates light near the subject vehicle M and measures scattered light. The finder 14 detects a distance to a target on the basis of a time from light emission to light reception. The radiated light is, for example, pulsed laser light. One or a plurality of finders 14 are attached to any places on the subject vehicle M.

The object recognition device 16 performs a sensor fusion process on detection results of some or all of the camera 10, the radar device 12, and the finder 14 to recognize a position, type, speed, and the like of an object. The object recognition device 16 outputs recognition results to the automated driving control device 100. The object recognition device 16 may output the detection results of the camera 10, the radar device 12, or the finder 14 to the automated driving control device 100 as they are according to necessity.

The communication device 20, for example, communicates with another vehicle near the subject vehicle M using a cellular network, a Wi-Fi network, Bluetooth (registered trademark), dedicated short range communication (DSRC), or the like or communicates with various server devices via a wireless base station.

The HMI 30 presents various types of information to an occupant of the subject vehicle M and receives an input operation from the occupant. The HMI 30 includes various display devices, speakers, buzzers, a touch panel, switches, keys, and the like.

The vehicle sensor 40 includes, for example, a vehicle speed sensor that detects a speed of the subject vehicle M, an acceleration sensor that detects an acceleration, a yaw rate sensor that detects an angular speed around a vertical axis, and an orientation sensor that detects a direction of the subject vehicle M.

The navigation device 50 includes, for example, a global navigation satellite system (GNSS) receiver 51, a navigation HMI 52, and a route determination unit 53, and holds first map information 54 in a storage device such as a hard disk drive (HDD) or a flash memory. The GNSS receiver 51 specifies a position of the subject vehicle M on the basis of a signal received from a GNSS satellite. The position of the subject vehicle M may be specified or supplemented by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. The route determination unit 53, for example, determines a route (hereinafter, an on-map route) from the position of the subject vehicle M (or any input position) specified by the GNSS receiver 51 to a destination input by the occupant using the navigation HMI 52 by referring to the first map information 54. The first map information 54 is, for example, information in which a road shape is represented by links indicating roads and nodes connected by the links. The first map information 54 may include a curvature of the road, point of interest (POI) information, and the like. The on-map route determined by the route determination unit 53 is output to the MPU 60. The navigation device 50 may perform route guidance using the navigation HMI 52 on the basis of the on-map route determined by the route determination unit 53. The navigation device 50 may be realized, for example, by a function of a terminal device such as a smartphone or a tablet terminal possessed by the occupant. The navigation device 50 may transmit a current position and a destination to a navigation server via the communication device 20 and acquire the on-map route with which the navigation server replies.

The MPU 60, for example, functions as a recommended lane determination unit 61, and holds second map information 62 in a storage device such as an HDD or a flash memory. The recommended lane determination unit 61 divides the route provided from the navigation device 50 into a plurality of blocks (for example, divides the route every 100 [m] in a progression direction of the vehicle), and determines a recommended lane for each block by referring to the second map information 62. The recommended lane determination unit 61 determines in which lane from the left the subject vehicle M travels. The recommended lane determination unit 61 determines the recommended lane so that the subject vehicle M can travel on a reasonable route for progression to a branch destination when there is a branch point, a merging point, or the like in the route.

The second map information 62 is map information with higher accuracy than the first map information 54. The second map information 62 includes, for example, information on a center of the lane or information on a boundary of the lane. The second map information 62 may include road information, traffic regulation information, address information (address and postal code), facility information, telephone number information, and the like. The second map information 62 may be updated at any time by accessing another device using the communication device 20.

The outside notification unit 70 notifies of information on a behavior of the subject vehicle M to the outside. The outside notification unit 70 includes, for example, blinkers 72 and a brake lamp 74. The blinkers 72 are disposed at predetermined positions between a front end portion and a rear end portion on the side of the subject vehicle. The blinkers 72 are disposed on left and right sides of the subject vehicle M. For the blinkers 72, the blinker on one of the right and left sides starts or stops blinking based on operation control of the outside notification control unit 170. The blinkers 72 may function as a hazard lamp (an emergency blinking light). In this case, the outside notification control unit 170 starts or stops blinking of the blinkers 72 on the left and right sides on the basis of the operation control of the outside notification control unit 170.

The brake lamp 74 is disposed at the rear end portion of the vehicle body of the subject vehicle M. Power of the brake lamp 74 starts or stops on the basis of the operation control of the outside notification control unit 170.

The driving operator 80 includes, for example, an accelerator pedal, a brake pedal, a shift lever, a steering wheel, a modified steering wheel, a joystick, and other operators. A sensor that detects the amount of operation or the presence or absence of the operation is attached to the driving operator 80, and a result of the detection is output to one or both of the automated driving control device 100, and the travel driving force output device 200, the brake device 210 and the steering device 220.

The automated driving control device 100 includes, for example, a first control unit 120, a second control unit 160, and an outside notification control unit 170. Each of the first control unit 120, the second control unit 160, and the outside notification control unit 170 is realized, for example, by a hardware processor such as a central processing unit (CPU) executing a program (software). Some or all of such components may be realized by hardware (including circuitry) such as a large scale integration (LSI), an application specific integrated circuit (ASIC), a field-programmable gate array (FPGA), or a graphics processing unit (GPU) or may be realized by software and hardware in cooperation.

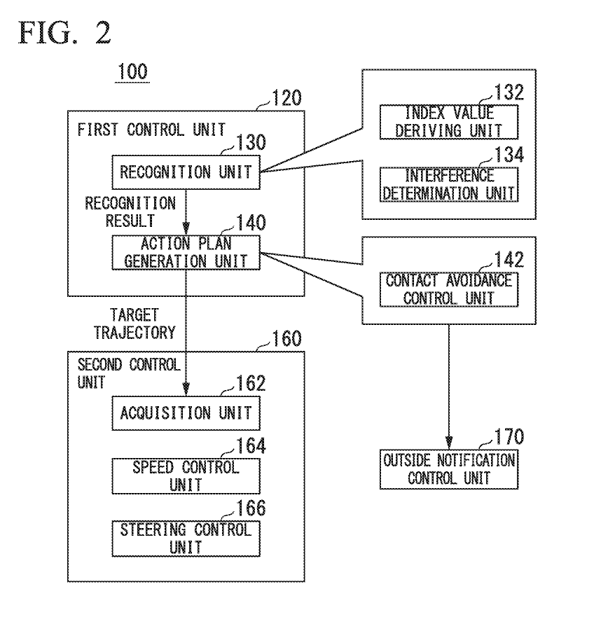

FIG. 2 is a functional configuration diagram of the first control unit 120 and the second control unit 160. In FIG. 2, the outside notification control unit 170 is illustrated. The first control unit 120 includes, for example, a recognition unit 130 and an action plan generation unit 140. The recognition unit 130 includes, for example, an index value deriving unit 132 and an interference determination unit 134. The action plan generation unit 140 includes, for example, a contact avoidance control unit 142. The index value deriving unit 132 is an example of a “deriving unit”. A combination of the outside notification unit 70 and the outside notification control unit 170 is an example of an “outside notification unit”. A combination of the interference determination unit 134, the contact avoidance control unit 142, and the second control unit 160 is an example of a “driving control unit”.

The first control unit 120 realizes, for example, a function based on artificial intelligence (AI) and a function based on a previously given model in parallel. For example, in a function of “recognizing an intersection,” recognition of the intersection through an image recognition scheme using deep learning or the like and recognition based on previously given conditions (a signal which can be subjected to pattern matching, a road sign, or the like) are executed in parallel, and the function of recognizing an intersection is realized by scoring both recognitions and comprehensively evaluating the recognitions. Accordingly, the reliability of automated driving is guaranteed.

The recognition unit 130 recognizes a position and a state such as a speed or an acceleration of an object near the subject vehicle M on the basis of information input from the camera 10, the radar device 12, and the finder 14 via the object recognition device 16. Examples of the object include a moving body such as a pedestrian, a bicycle, another vehicle, and a stationary obstacle. Examples of the other vehicle include a preceding vehicle, a following vehicle, and other vehicles traveling in the vicinity. When the object is the moving body, the position of the object is recognized, for example, as a position based on absolute coordinates with a representative point (for example, a centroid or a driving axis center) of the subject vehicle M as an origin, and is used for control. The position of the object may be represented by a representative point such as a centroid or a corner of the object or may be represented by an indicated area. The “state” of the object may include an acceleration or jerk of the object, or an “action state” (for example, whether or not the object is changing lanes or is about to change lanes). The recognition unit 130 recognizes a shape of a curve that the subject vehicle M is about to pass on the basis of a captured image of the camera 10. The recognition unit 130 converts the shape of the curve from the captured image of the camera 10 to a real plane and outputs, for example, two-dimensional point sequence information or information represented by using a model equivalent thereto to the action plan generation unit 140 as information indicating the shape of the curve.

The recognition unit 130 recognizes a lane (traveling lane) in which the subject vehicle M is traveling. For example, the recognition unit 130 compares a pattern of a road marking line (for example, an arrangement of a solid line and a broken line) obtained from the second map information 62 with a pattern of a road marking line near the subject vehicle M recognized from the image captured by the camera 10 to recognize the traveling lane. The recognition unit 130 may recognize not only the road marking line but also a traveling road boundary (road boundary) including the road marking line, a road shoulder, a curb, a median strip, a guard rail, or the like to recognize the traveling lane. In this recognition, the position of the subject vehicle M acquired from the navigation device 50 or a processing result of an INS may be added. The recognition unit 130 recognizes a temporary stop line, an obstacle, a traffic light, a toll gate, and other road events.

The recognition unit 130 recognizes a position or a posture of the subject vehicle M relative to the traveling lane in a case that recognizing the traveling lane. The recognition unit 130 may recognize, for example, a deviation of a reference point of the subject vehicle M from a center of the lane, and an angle formed between a progression direction of the subject vehicle M and a line connecting a center of a lane as a relative position and a posture of the subject vehicle M with respect to the traveling lane. Instead, the recognition unit 130 may recognize, for example, a position of the reference point of the subject vehicle M with respect to any one of side end portions (the road marking line or the road boundary) of the traveling lane as the relative position of the subject vehicle M with respect to the traveling lane.

The recognition unit 130 may derive recognition accuracy in the above recognition process and output the recognition accuracy as recognition accuracy information to the action plan generation unit 140. For example, the recognition unit 130 generates the recognition accuracy information on the basis of a frequency of recognition of the road marking lines in a certain period. Functions of the index value deriving unit 132 and the interference determination unit 134 of the recognition unit 130 will be described below.

In principle, the action plan generation unit 140 determines events to be sequentially executed in automated driving so that the subject vehicle M can travel on the recommended lane determined by the recommended lane determination unit 61 and cope with the surrounding situation of the subject vehicle M. Events include, for example, a constant speed traveling event in that a vehicle travels on the same lane at a constant speed, a following traveling event in which a vehicle follows a preceding vehicle, an overtaking event in which a vehicle overtakes a preceding vehicle, an avoidance event in which a vehicle performs braking and/or steering for avoiding approaching an obstacle, a curved traveling event in which a vehicle travels on a curve, a passage event in which a vehicle passes through a predetermined point such as an intersection, a crosswalk, a railroad crossing, or a traffic light, a lane change event, a merging event, a branching event, an automated stop event, and a takeover event for ends automated driving and switching to manual driving.

The action plan generation unit 140 generates a target trajectory along which the subject vehicle M will travel in the future according to an activated event. The target trajectory includes, for example, a speed element. For example, the target trajectory is represented as a sequence of points (trajectory points) to be reached by the subject vehicle M. The trajectory point is a point that the subject vehicle M is to reach for each predetermined travel distance (for example, several meters) at a road distance, and a target speed and a target acceleration at every predetermined sampling time (for example, several tenths of a [sec]) are separately generated as part of the target trajectory. The trajectory point may be a position that the subject vehicle M is to reach at the sampling time at every predetermined sampling time. In this case, information on the target speed or the target acceleration is represented by the interval between the trajectory points.

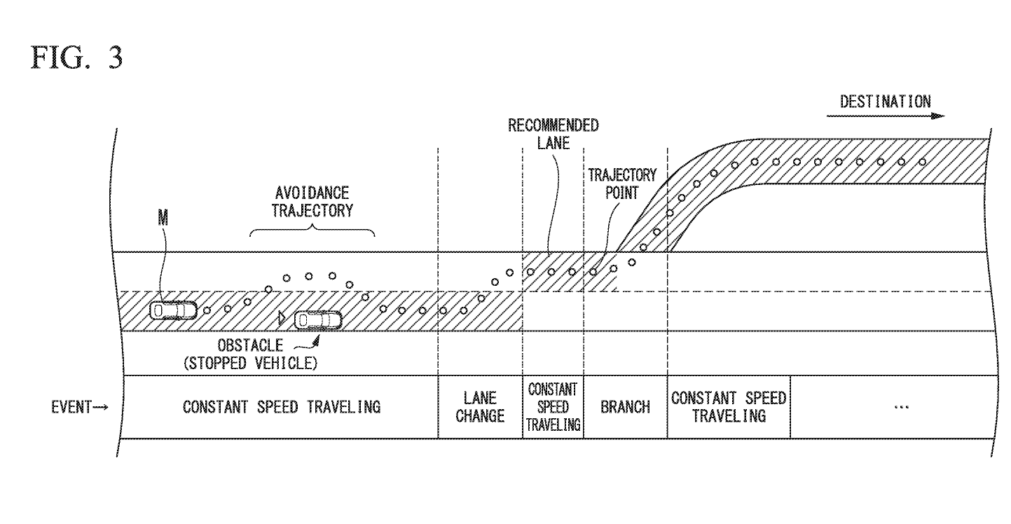

FIG. 3 is a diagram illustrating a state in which the target trajectory is generated on the basis of the recommended lane. As illustrated in FIG. 3, the recommended lane is set so that a vehicle conveniently travels along a route to a destination. The action plan generation unit 140 activates the passage event, the lane change event, the branching event, the merging event, or the like in a case that a vehicle approach a predetermined distance (which may be determined according to a type of event) at a point at which the recommended lane is switched. In a case that it is necessary to avoid an obstacle during the execution of each event, an avoidance trajectory is generated as illustrated in FIG. 3. A function of the contact avoidance control unit 142 of the action plan generation unit 140 will be described below.

The second control unit 160 controls the travel driving force output device 200, the brake device 210, and the steering device 220 so that the subject vehicle M passes through the target trajectory generated by the action plan generation unit 140 or the contact avoidance control unit 142 at a scheduled time.

Referring back to FIG. 2, the second control unit 160 includes, for example, an acquisition unit 162, a speed control unit 164, and a steering control unit 166. The acquisition unit 162 acquires information on the target trajectory (trajectory points) generated by the action plan generation unit 140 or the contact avoidance control unit 142 and stores the information on the target trajectory in a memory (not illustrated). The speed control unit 164 controls the travel driving force output device 200 or the brake device 210 on the basis of the speed element incidental to the target trajectory stored in the memory. The steering control unit 166 controls the steering device 220 according to a degree of bend of the target trajectory stored in the memory. Processes of the speed control unit 164 and the steering control unit 166 are realized by, for example, a combination of feedforward control and feedback control. For example, the steering control unit 166 executes a combination of feedforward control according to a curvature of a road in front of the subject vehicle M and feedback control based on a deviation from the target trajectory.

The outside notification control unit 170 controls start or end of an operation of the outside notification unit 70. For example, in a case that the outside notification control unit 170 receives a manipulation of a blinker lever (not illustrated) which is a switch for instructing an operation of the blinker 72, the outside notification control unit 170 turns on the blinker 72 corresponding to an instructed direction or causes the blinker 72 to blink. The outside notification control unit 170 turns on the blinker 72 or causes the blinker 72 to blink in a direction corresponding to the progression direction of the subject vehicle M in a case that a route of the subject vehicle M is changed in the target trajectory generated by the action plan generation unit 140. The route change is, for example, right turn, left turn, or lane change of subject vehicle M. The lane change is, for example, a case in which the lane is changed from a traveling lane to an adjacent lane in a plurality of lanes having the same progression direction, or a case in which a lane is changed due to branching or merging.

For example, in a case that an occupant of the subject vehicle M has executed a manipulation with respect to the brake device 210, the outside notification control unit 170 turns on the brake lamp 74. The manipulation with respect to the brake device 210 is, for example, a manipulation in which the occupant depresses the brake pedal. The outside notification control unit 170 turns on the brake lamp 74 in a case that control of the brake device 210 is being executed according to deceleration control of the speed control unit 164. The outside notification control unit 170 turns on the brake lamp 74 at a predetermined timing on the basis of contact avoidance control of the contact avoidance control unit 142. Details of the function of the outside notification control unit 170 will be described below.

The travel driving force output device 200 outputs a travel driving force (torque) for traveling of the vehicle to the driving wheels. The travel driving force output device 200 includes, for example, a combination of an internal combustion engine, an electric motor, a transmission, and the like, and an ECU that controls these. The ECU controls the above configuration according to information input from the second control unit 160 or information input from the driving operator 80.

The brake device 210 includes, for example, a brake caliper, a cylinder that transfers hydraulic pressure to the brake caliper, an electric motor that generates hydraulic pressure in the cylinder, and a brake ECU. The brake ECU controls the electric motor according to information input from the second control unit 160 or information input from the driving operator 80 so that a brake torque according to a braking operation is output to each wheel. The brake device 210 may include a mechanism that transfers the hydraulic pressure generated by the operation of the brake pedal included in the driving operator 80 to the cylinder via a master cylinder as a backup.

The brake device 210 is not limited to the configuration described above and may be an electronically controlled hydraulic brake device that controls the actuator according to information input from the second control unit 160 and transfers the hydraulic pressure of the master cylinder to the cylinder.

The steering device 220 includes, for example, a steering ECU and an electric motor. The electric motor, for example, changes a direction of the steerable wheels by causing a force to act on a rack and pinion mechanism. The steering ECU drives the electric motor according to information input from the second control unit 160 or information input from the driving operator 80 to change the direction of the steerable wheels.

[Function of Index Value Deriving Unit]

The index value deriving unit 132 derives an index value indicating that the following vehicle present behind the subject vehicle in the subject lane among the moving bodies recognized by the recognition unit 130 approaches the subject vehicle M.

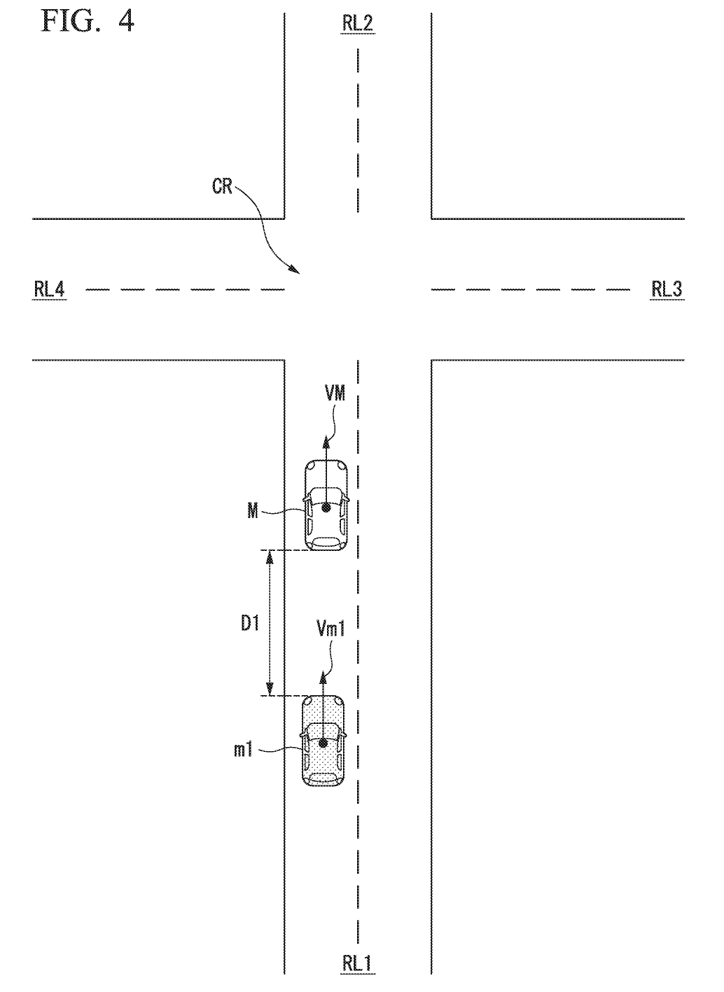

FIG. 4 is a diagram illustrating an example of a process of the index value deriving unit 132. In the example of FIG. 4, road links RL1 to RL4 connected to an intersection CR are shown. The road link RL is obtained by cutting out a road between a node and a node in map information, and is typically a road corresponding to one block. In the road links RL1 to RL4 illustrated in FIG. 4, a road marking line that partitions a traveling lane of the subject vehicle M and an opposite lane within the same road link is shown.

The recognition unit 130 recognizes the traveling road link RL1, the other road links RL 2 to RL4, the road marking lines, and the intersection CR. The recognition unit 130 recognizes a following vehicle ml as a moving body present in the vicinity.

The recognition unit 130 recognizes a position or a speed VM of the subject vehicle M and a position and a speed Vm1 of the following vehicle ml in the traveling road link RL1.

The index value deriving unit 132 derives an inter-vehicle distance D1 between the subject vehicle M and the following vehicle ml recognized by the recognition unit 130 as an index value (hereinafter referred to as a first index value). The inter-vehicle distance D1 is, for example, a distance from a rear end portion of the vehicle body of the subject vehicle M to a front end portion of the following vehicle ml.

The index value deriving unit 132 may derive a headway time obtained by dividing a relative distance between the subject vehicle M and the following vehicle ml by a speed of the following vehicle as an index value (hereinafter referred to as a second index value). The relative distance is, for example, the inter-vehicle distance D1. The relative distance may be a distance from a centroid of the subject vehicle M to a centroid of the following vehicle ml or a distance from a front end portion of the subject vehicle M to a front end portion of the following vehicle ml.

The index value deriving unit 132 may derive a margin time until the subject vehicle M comes into contact with the following vehicle ml (TTC: Time To Collision), which is obtained by dividing the relative distance between the subject vehicle M and the following vehicle ml by the relative speed between the subject vehicle M and the following vehicle ml, as an index value (hereinafter referred to as a third index value).

Here, the smaller the first to third index values, the higher the likelihood of the subject vehicle M and the following vehicle ml coming in contact with each other. Therefore, for example, in a case that the subject vehicle M changes a route on the basis of the target trajectory generated by the action plan generation unit 140, the contact avoidance control unit 142 determines whether or not at least one index value among the first to third index values derived by the index value deriving unit 132 is smaller than a threshold value. In a case that the at least one index value is smaller than the threshold value, the contact avoidance control unit 142 performs predetermined control for avoiding contact with the following vehicle ml. The predetermined control means, for example, to make a timing of blinking of the blinker 72 earlier than a timing of turn-on of the blinker 72 at a normal time or to make a timing of turn-on of the brake lamp 74 earlier than a timing of turn-on of the brake lamp 74 at a normal time. The normal time is, for example, a case in which the first to third index values are equal to or greater than first to third threshold values. The normal time is, for example, a state in which the subject vehicle M and the following vehicle ml do not approach each other or a state in which it is not predicted that the subject vehicle M and the following vehicle ml will approach each other in the near future. The contact avoidance control unit 142 may select at least one of the first to third index values, and execute control for avoidance of contact with the following vehicle ml on the basis of whether or not the selected index value is smaller than the threshold value.

[Function of Contact Avoidance Control Unit]

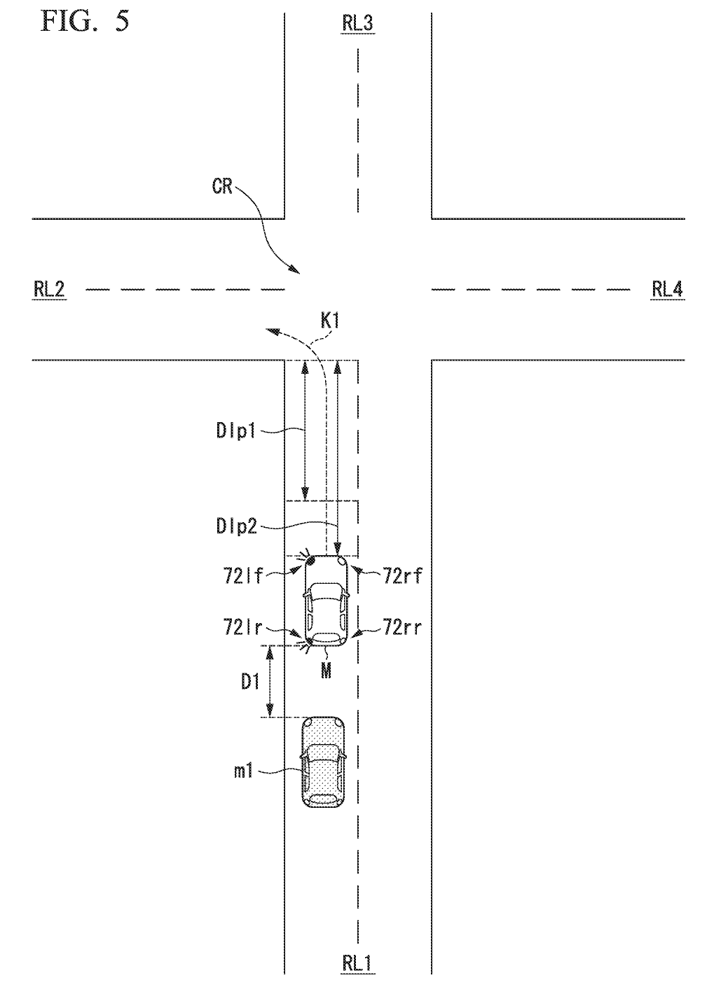

FIG. 5 is a diagram illustrating an example of a process of the contact avoidance control unit 142. FIG. 5 illustrates a scene in which the subject vehicle M traveling on the road link RL1 turns left at the intersection CR and travels on the road link RL2 that is another lane on the basis of the target trajectory K1 generated by the action plan generation unit 140. In the example of FIG. 5, it is assumed that blinkers 721f, 72rf, 721r, and 72rr are provided in the subject vehicle M.

In the scene illustrated in FIG. 5, the contact avoidance control unit 142 determines whether or not the subject vehicle M turns left and the inter-vehicle distance D1 between the subject vehicle M and the following vehicle ml derived by the index value deriving unit 132 is less than a predetermined distance Dth that is a first threshold value. In a case that the inter-vehicle distance D1 is less than the predetermined distance Dth, the contact avoidance control unit 142, at the normal time, causes the outside notification control unit 170 to cause the blinker 72 to blink at a timing earlier than a timing of blinking of the blinker 72 at the normal time.

For example, in automated driving, in a case that the blinkers 721f and 721r provided on the left side of the vehicle body of the subject vehicle M are cause to blink at a timing when the traveling subject vehicle M has reached a distance Dlp1 from a link portion between the road link RL1 and the intersection CR at the normal time, the contact avoidance control unit 142 causes the blinkers 721f and 721r to blink at a timing when the traveling subject vehicle M has reached a distance Dlp2 longer than the distance Dlp1. In a case that the subject vehicle M turns left and the inter-vehicle distance D1 between the subject vehicle M and the following vehicle ml is equal to or greater than the predetermined distance Dth, the second control unit 160 causes the blinkers 721f and 721r to blink at a timing at a normal time (a timing at which the subject vehicle M has reached the distance Dlp1).

Accordingly, in a case that the following vehicle ml is approaching the subject vehicle M, it is possible to notify the occupant of the following vehicle ml of a near future behavior of the subject vehicle M earlier than usual. Thus, it is possible to suppress contact with the following vehicle ml.

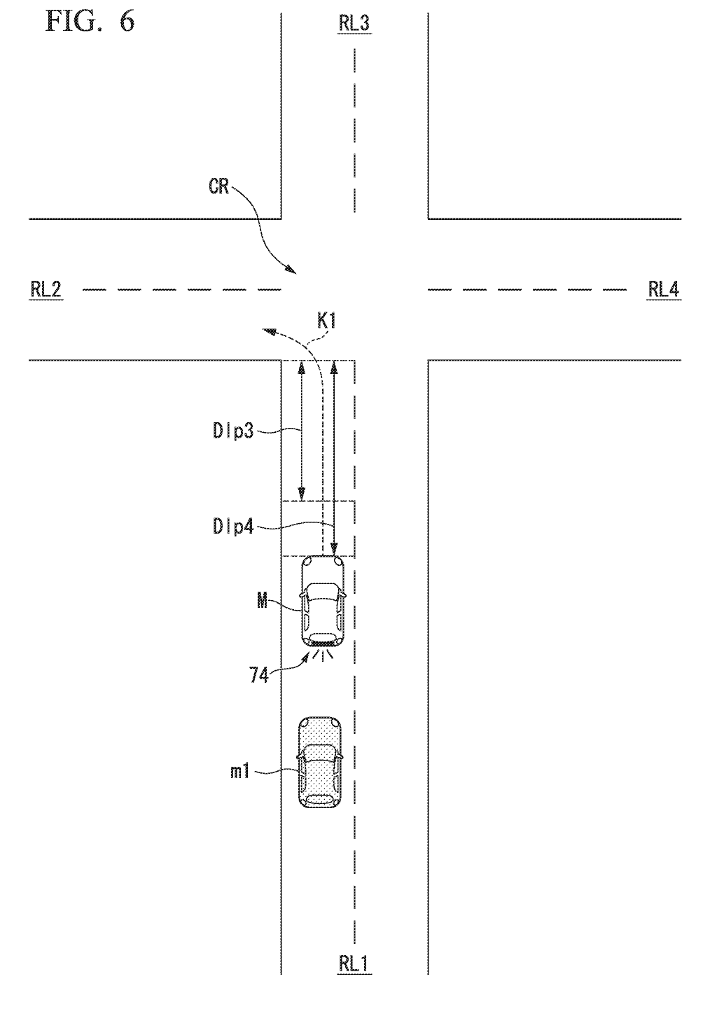

The contact avoidance control unit 142 may cause the outside notification control unit 170 to execute predetermined control in a case that the headway time is less than a predetermined time Tth1 that is a second threshold value in place of (or in addition to) the inter-vehicle distance D1 described above. This control is referred to as first contact avoidance control. FIG. 6 is a diagram illustrating an example of the first contact avoidance control. FIG. 6 illustrates an example of the predetermined control in which the brake lamp 74 provided at the rear end of the vehicle body of the subject vehicle M is turned on.

The contact avoidance control unit 142 determines whether the subject vehicle M turns left along the target trajectory K1 and the headway time between the subject vehicle M and the following vehicle ml derived by the index value deriving unit 132 is less than the predetermined time Tth1. When the headway time is less than the predetermined time Tth1, the contact avoidance control unit 142, at a normal time, causes the outside notification control unit 170 to turn on the brake lamp 74 at a timing earlier than a timing of turn-on of the brake lamp 74 at the normal time.

For example, in automated driving, in a case in which the brake lamp 74 has been turned on at a timing when the traveling subject vehicle M has reached a distance Dlp3 from a link portion between the road link RL1 and the intersection CR at the normal time, the contact avoidance control unit 142 turns on the brake lamp 74 at a timing when the subject vehicle M has reached a distance Dlp4 longer than the distance Dlp3. The distance Dlp3 may be the same distance as the distance Dlp1 and the distance Dlp4 may be the same distance as the distance Dlp2.

The contact avoidance control unit 142 generates a target trajectory for decelerating the subject vehicle M turning left at a timing when the outside notification control unit 170 is caused to turn on the brake lamp 74 at a timing when the subject vehicle M has reached the distance Dlp4. Accordingly, deceleration can be started in a case that the brake lamp 74 has been turned on.

The contact avoidance control unit 142 may turn on the brake lamp 74 before starting deceleration control for left turn of the subject vehicle M. In this case, the contact avoidance control unit 142 turns on the brake lamp 74 at a timing when the subject vehicle M has reached the distance Dlp4, and starts the deceleration control at a timing when the subject vehicle M has reached the distance Dlp3.

The contact avoidance control unit 142 may cause the outside notification control unit 170 to temporarily cause the hazard lamp to blink instead of turning on the brake lamp 74 at a timing when the subject vehicle M has reached the distance Dlp4. In this case, the contact avoidance control unit 142 causes the hazard lamps (for example, the blinkers 721f, 72rf, 721r, and 72rr) to blink at a timing when the subject vehicle M has reached the distance Dlp4, causes the blinking of the hazard lamps to end at a timing when the subject vehicle M has reached the distance Dlp3, and causes the blinkers 721f and 721r to blink or causes the brake lamp 74 to be turned on to start the deceleration control.

The contact avoidance control unit 142 may alternatively repeat the acceleration and deceleration of the subject vehicle M temporarily instead of causing the outside notification control unit 170 to turn on the brake lamp 74 at a timing when the subject vehicle M has reached the distance Dlp4. In this case, the contact avoidance control unit 142 executes control for repeating the acceleration and deceleration of the subject vehicle M at a timing when the subject vehicle M has reached the distance Dlp4, causes blinking of the hazard lamp to end at a timing when the subject vehicle M has reached Dlp3, and causes the brake lamp 74 to be turned on to start the deceleration control.

The contact avoidance control unit 142 may execute the blinking of the blinker 72, the turn-on of the brake lamp 74, or the like earlier than control at a normal time in the automated driving to perform the contact avoidance control in a case that a margin time until the subject vehicle M comes in contact with the following vehicle ml is less than a predetermined time Tth2 that is a third threshold value, instead of (or in addition to) the inter-vehicle distance D1 and the headway time described above.

[Function of Interference Determination Unit]

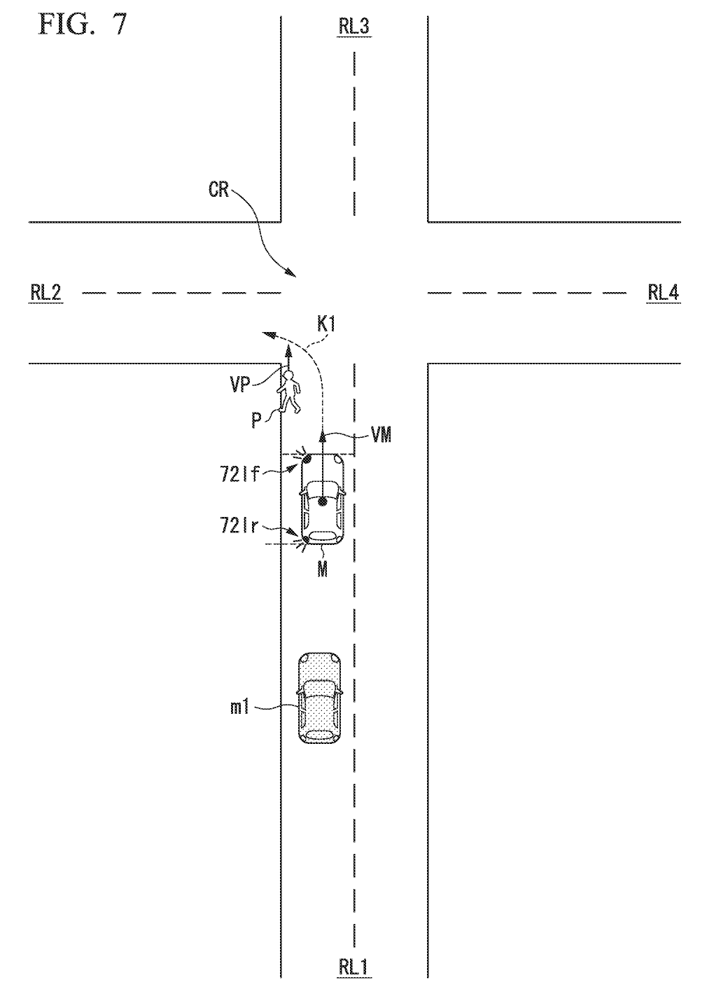

The contact avoidance control unit 142 may execute predetermined control for avoiding contact with a moving body on the basis of a result of a determination on whether or not the moving body present near the subject vehicle M and the subject vehicle M interfere each other. This control is referred to as a second contact avoidance control. FIG. 7 is a diagram illustrating an example of the second contact avoidance control. FIG. 7 illustrates an example in which the pedestrian P is present in a direction in which the subject vehicle M turns left at the intersection CR along the target trajectory K1.

The interference determination unit 134 predicts a future movement route on the basis of a current position, a movement speed VP, and a movement direction of the pedestrian P recognized by the recognition unit 130, and predicts whether the subject vehicle M and the pedestrian P will interfere each other on the basis of the predicted future movement route (hereinafter referred to as a predicted movement route) and the target trajectory K1 of the subject vehicle M. For example, the interference determination unit 134 determines that the subject vehicle M and the pedestrian P interfere with each other in a case that the target trajectory K1 of the subject vehicle M crosses the predicted movement route of the pedestrian P1 at a certain time. In a case that the target trajectory K1 of the subject vehicle M does not cross the predicted movement route of the pedestrian P1 at a certain time, the interference determination unit 134 determines that the subject vehicle M and the pedestrian P do not interfere each other.

The interference determination unit 134 may set a predetermined width (range) in the target trajectory K1 in the future of the subject vehicle and the movement route of the pedestrian P on the basis of the shapes of the subject vehicle M and the pedestrian P, and determine whether or not the subject vehicle M and the pedestrian P interfere with each other on the basis of whether or not at least parts of areas formed by the respective width overlap each other at a certain time. In this case, the interference determination unit 134 determines that the subject vehicle M and the pedestrian P interfere with each other when at least the parts of the respective areas overlap each other at a certain time, and determines that the subject vehicle M and the pedestrian P do not interfere each other when at least the parts of the respective areas do not overlap each other.

In a case that the interference determination unit 134 determines that the subject vehicle M and the pedestrian P interfere with each other, the contact avoidance control unit 142 executes driving control for accelerating or decelerating the subject vehicle M to avoid contact between the subject vehicle M and the pedestrian P. Specifically, the contact avoidance control unit 142 generates a target trajectory in which the subject vehicle M is decelerated or stopped before the subject vehicle M turns left at an intersection, the pedestrian P is caused to cross the intersection CR first, and then, the subject vehicle M turns left at the intersection CR. The contact avoidance control unit 142 generates a target trajectory in which the subject vehicle M is accelerated and the left turn is completed before the pedestrian P starts crossing. Accordingly, the subject vehicle M can travel without interfering with surrounding moving bodies.

[Process Flow]

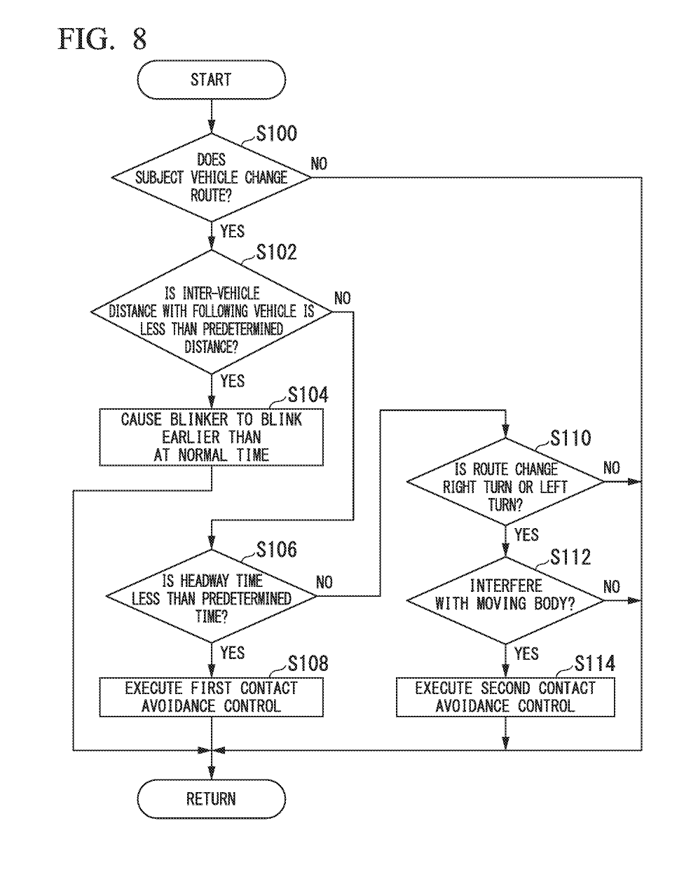

FIG. 8 is a flowchart illustrating an example of a process that is executed by the automated driving control device 100 according to the embodiment. A process of this flowchart may be repeatedly executed at a predetermined cycle or predetermined timing, for example. In the process of this flowchart, it is assumed that automated driving is being executed on the basis of the target trajectory generated by the action plan generation unit 140 in the subject vehicle M.

First, the first control unit 120 determines whether or not the subject vehicle M changes the route on the basis of the position of the subject vehicle M and the target trajectory of the subject vehicle M (step S100). When it is determined that the subject vehicle M changes the route, the contact avoidance control unit 142 determines whether or not the inter-vehicle distance D1 with the following vehicle ml derived by the index value deriving unit 132 is less than a predetermined distance Dthl (step S102). When it is determined that the inter-vehicle distance with the following vehicle is less than the predetermined distance Dthl, the contact avoidance control unit 142 causes the blinker corresponding to a route change destination of the subject vehicle M to blink earlier than the blinking of the blinker at a normal time (step S104).

When it is determined in the process of step S102 that the inter-vehicle distance with the following vehicle ml is equal to or greater than the predetermined distance, the contact avoidance control unit 142 determines whether the headway time with the following vehicle ml derived by the index value deriving unit 132 is less than the predetermined time Tth1 (step S106). When it is determined that the headway time with the following vehicle ml is less than the predetermined time Tth1, the contact avoidance control unit 142 executes the first contact avoidance control (step S108).

When it is determined in the process of step S106 that the headway time is equal to or more than the predetermined time Tth1, the contact avoidance control unit 142 determines whether the route change is a right turn or a left turn of the subject vehicle M (step S110). When it is determined that the route change is a right turn or a left turn of the subject vehicle M, the interference determination unit 134 determines whether or not the subject vehicle M interferes with the moving body present near the subject vehicle M recognized by the recognition unit 130 (step S112). When it is determined that the subject vehicle M interferes with the moving body, the contact avoidance control unit 142 executes the second contact avoidance control (step S114). Accordingly, this flowchart ends. When it is determined in the process of step S100 that the subject vehicle M does not change the route, when it is determined in the process of step S110 that the route change of the subject vehicle is not the right turn or the left turn, or when it is determined in the process of step S112 that the subject vehicle M does not interfere with the moving body, this flowchart ends. Although the process of combining the first index value (the inter-vehicle distance) and the second index value (the headway time) described above has been described in the process flow of FIG. 8, the contact avoidance control of the embodiment may be performed by using the third index value (the margin time up to contact) instead of (or in addition to) such a process. In the embodiment, for example, the process of step S104 and the process of step S108 illustrated in FIG. 8 may be interchanged.

According to the above-described embodiment, it is possible to execute more appropriate contact avoidance control for the moving body such as the following vehicle ml or the pedestrian P by including the recognition unit 130 that recognizes moving bodies present near the subject vehicle M, the index value deriving unit 132 that derives the index value indicating that the following vehicle ml present behind the subject vehicle M in the subject lane among the moving bodies recognized by the recognition unit 130 approaches the subject vehicle M, and the contact avoidance control unit 142 and the second control unit 160 that perform predetermined control in a case that the index value derived by the index value deriving unit 132 is smaller than the threshold value in a case in which the subject vehicle M changes the route to another lane.

According to the above-described embodiment, in a case that the subject vehicle M changes the route and the following vehicle ml is approaching or is likely to approach in the future, the blinkers 72 or the brake lamp 74 is caused to operate earlier than a normal time. Thus, it is possible to cause an occupant of the following vehicle ml to recognize a behavior of the subject vehicle M and to suppress contact between the subject vehicle M and the following vehicle ml. According to the embodiment described above, it is possible to execute more appropriate contact avoidance control by performing driving control so that the subject vehicle M does not interfere with a pedestrian or a bicycle near the intersection in a case that the subject vehicle M turns right or left.

[Hardware Configuration]

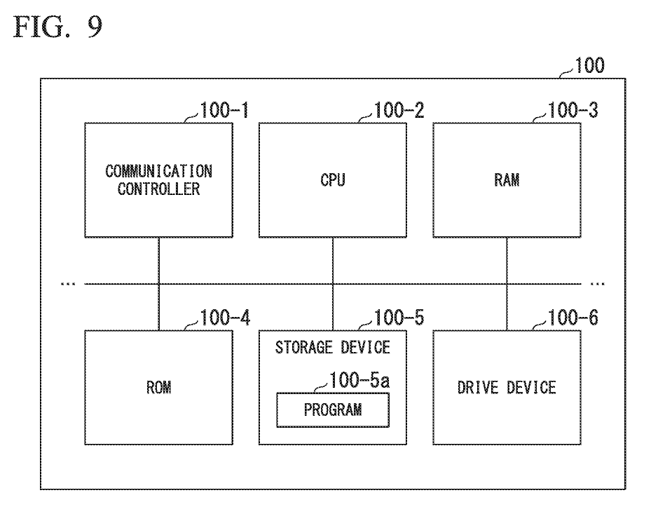

The automated driving control device 100 of the embodiment described above is realized by, for example, a hardware configuration as illustrated in FIG. 9. FIG. 9 is a diagram illustrating an example of a hardware configuration of the automated driving control device 100 according to the embodiment.

The automated driving control device 100 has a configuration in which a communication controller 100-1, a CPU 100-2, a RAM 100-3, a ROM 100-4, a storage device 100-5 such as a flash memory or an HDD, and a drive device 100-6 are connected to each other by an internal bus or a dedicated communication line. A portable storage medium (for example, a computer-readable non-transitory storage medium) such as an optical disc is mounted on the drive device 100-6. A program 100-5a stored in the storage device 100-5 is developed in the RAM 100-3 by a DMA controller (not illustrated) or the like and executed by the CPU 100-2, such that the first control unit 120 and the second control unit 160 are realized. A program referred to by the CPU 100-2 may be stored in a portable storage medium mounted on the drive device 100-6 or may be downloaded from another device via a network NW.

The above embodiment can be represented as follows.

A vehicle control device including

a storage device that stores information, and

a hardware processor that executes a program stored in the storage device,

wherein the hardware processor is configured to

recognize moving bodies present near a subject vehicle,

derive an index value indicating that a following vehicle present behind the subject vehicle in a subject lane among the recognized moving bodies approaches the subject vehicle, and

perform predetermined control in a case that the derived index value is smaller than a threshold value in a case that the subject vehicle changes a route to another lane.

Although a mode for carrying out the present invention has been described above using the embodiment, the present invention is not limited to the embodiment at all, and various modifications and substitutions may be made without departing from the spirit of the present invention.

What is claimed is:

1. A vehicle control device comprising:
a recognition unit that recognizes moving bodies present near a subject vehicle;
a deriving unit that derives an index value indicating that a following vehicle present behind the subject vehicle in a subject lane among the moving bodies recognized by the recognition unit approaches the subject vehicle; and
a driving control unit that performs predetermined control in a case that the index value derived by the deriving unit is smaller than a threshold value in a case that the subject vehicle changes a route to another lane.

2. The vehicle control device according to claim 1, further comprising an outside notification unit that performs a predetermined notification to surroundings of the subject vehicle,
wherein the driving control unit performs a notification using the outside notification unit in a case in which the index value derived by the deriving unit is smaller than a threshold value in a case that the subject vehicle changes a route to another lane.

3. The vehicle control device according to claim 1, wherein the deriving unit derives a headway time obtained by dividing a relative distance between the subject vehicle and the following vehicle by a speed of the following vehicle, as the index value.

4. The vehicle control device according to claim 1, wherein the driving control unit performs the predetermined control in a case that it is predicted that the moving body recognized by the recognition unit will interfere with the subject vehicle in a case that the subject vehicle turns right or turns left to change the route.

5. A vehicle control method comprising:
recognizing, by a recognition unit, moving bodies present near a subject vehicle;
deriving, by a deriving unit, an index value indicating that a following vehicle present behind the subject vehicle in a subject lane among the moving bodies recognized by the recognition unit approaches the subject vehicle; and
performing, by a driving control unit, predetermined control in a case that the index value derived by the deriving unit is smaller than a threshold value in a case that he subject vehicle changes a route to another lane.

6. A computer-readable non-transitory storage medium storing a program, the program causing a computer to:
recognize moving bodies present near a subject vehicle;
derive an index value indicating that a following vehicle present behind the subject vehicle in a subject lane among the recognized moving bodies approaches the subject vehicle; and
perform predetermined control in a case that the derived index value is smaller than a threshold value in a case that the subject vehicle changes a route to another lane.
